(19) United States
(12) Patent Application Publication
(10) Pub. No.: US 2023/0327081 A1
(43) Pub. Date: Oct. 12, 2023

(54) Negative Electrode and Non-Aqueous Electrolyte Secondary Battery

(71) Applicant: Prime Planet Energy & Solutions, Inc., Tokyo (JP)

(72) Inventors: Kouhei TSUZUKI, Kobe-shi (JP); Naoto ONODERA, Kobe-shi (JP); Hideki SANO, Osaka (JP); Yuki MORIKAWA, Kobe-shi (JP); Yurika KOJIMA, Kobe-shi (JP)

(21) Appl. No.: 18/296,374

(22) Filed: Apr. 6, 2023

(30) Foreign Application Priority Data
Apr. 7, 2022 (JP) 2022-063895

(51) Int. Cl. H01M 4/36; H01M 4/38; H01M 4/62; H01M 4/583; H01M 4/04

(52) U.S. Cl. CPC H01M 4/364; H01M 4/386; H01M 4/622; H01M 2004/027; H01M 4/0404; H01M 4/366; H01M 4/583

(57) ABSTRACT

The present disclosure relates to a negative electrode for a non-aqueous electrolyte secondary battery, wherein each of first silicon-containing particles and second silicon-containing particles contains a carbon domain and a silicon domain dispersed in the carbon domain and having a nano size, each of a first binder and a second binder contains carboxymethyl cellulose (CMC), and a content ratio of the carboxymethyl cellulose in a second active material layer is more than a content ratio of the carboxymethyl cellulose in a first active material layer.

This nonprovisional application is based on Japanese Patent Application No. 2022-063895 filed on Apr. 7, 2022 with the Japan Patent Office, the entire contents of which are hereby incorporated by reference.

### BACKGROUND OF THE INVENTION

### Field of the Invention

The present disclosure relates to a negative electrode, and also relates to a non-aqueous electrolyte secondary battery.

### Description of the Background Art

Japanese National Patent Publication No. 2018-521448 proposes a negative electrode active material including silicon-containing particles (SiC) in each of which a silicon domain is dispersed in a carbon matrix.

### SUMMARY OF THE INVENTION

In a negative electrode including silicon-containing particles (SiC) each having a small silicon domain size, the SiC is likely to be suppressed from being cracked due to expansion and contraction resulting from repeated charging and discharging, whereas carboxymethyl cellulose (CMC) used for binding to a carbon matrix existing at a surface of the SiC tends to be likely to be broken during rolling, with the result that a decrease in capacity tends to be large. It is an object of the present disclosure to provide: a negative electrode including silicon-containing particles and allowing for suppression of decreased cycling performance; and a non-aqueous electrolyte secondary battery.

The present disclosure provides the following negative electrode and non-aqueous electrolyte secondary battery.

[1] A negative electrode for a non-aqueous electrolyte secondary battery, the negative electrode comprising a current collector, a first active material layer, and a second active material layer that are provided in this order, wherein
the first active material layer includes first silicon-containing particles and a first binder,
the second active material layer includes second silicon-containing particles and a second binder,
each of the first silicon-containing particles and the second silicon-containing particles contains a carbon domain and a silicon domain dispersed in the carbon domain and having a nano size,
each of the first binder and the second binder contains carboxymethyl cellulose (CMC), and
a content ratio of the carboxymethyl cellulose in the second active material layer is more than a content ratio of the carboxymethyl cellulose in the first active material layer.

[2] The negative electrode according to [1], wherein the content ratio of the carboxymethyl cellulose in the second active material layer is 0.7 wt % or more and 3 wt % or less, and the content ratio of the carboxymethyl cellulose in the first active material layer is 0.5 wt % or more and 1.5 wt % or less.

[3] The negative electrode according to [1] or [2], wherein each of the first silicon-containing particles and the second silicon-containing particles is constituted of the carbon domain and the silicon domain having a size of 50 nm or less, and has an oxygen content ratio of 7 wt % or less.

[4] The negative electrode according to any one of [1] to [3], wherein

the first active material layer includes first graphite particles,

the second active material layer includes second graphite particles, and

each of a BET specific surface area of the first graphite particles and a BET specific surface area of the second graphite particles is 3.5 m²/g or less, and each of a particle size distribution (D90-D10)/(D50) of the first graphite particles and a particle size distribution (D90-D10)/(D50) of the second graphite particles is 1.2 or more.

[5] The negative electrode according to any one of [1] to [4], wherein each of the first active material layer and the second active material layer includes a single-walled carbon nanotube.

[6] The negative electrode according to any one of [1] to [5], wherein a molecular weight of the carboxymethyl cellulose in the second active material layer is more than a molecular weight of the carboxymethyl cellulose in the first active material layer.

[7] A non-aqueous electrolyte secondary battery comprising: the negative electrode according to any one of [1] to [6]; and an exterior package.

[8] The non-aqueous electrolyte secondary battery according to [7], comprising an electrode assembly including the negative electrode, wherein a ratio T/D of a thickness T of the electrode assembly to a distance D between the electrode assembly and the exterior package is 2% or more at a voltage of 3 V or less.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an exemplary configuration of a negative electrode according to the present embodiment.

FIG. 2 is a schematic flowchart showing a method of producing the negative electrode.

FIG. 3 is a schematic diagram showing an exemplary configuration of a battery according to the present embodiment.

FIG. 4 is a schematic diagram showing an exemplary configuration of an electrode assembly according to the present embodiment.

### DESCRIPTION OF THE PREFERRED EMBODIMENTS

Hereinafter, embodiments of the present disclosure will be described with reference to figures; however, the present disclosure is not limited to the below-described embodiments. In all the below-described figures, scales are appropriately adjusted to facilitate understanding of respective components, and the scales of the respective components shown in the figures do not necessarily coincide with actual scales of the respective components.

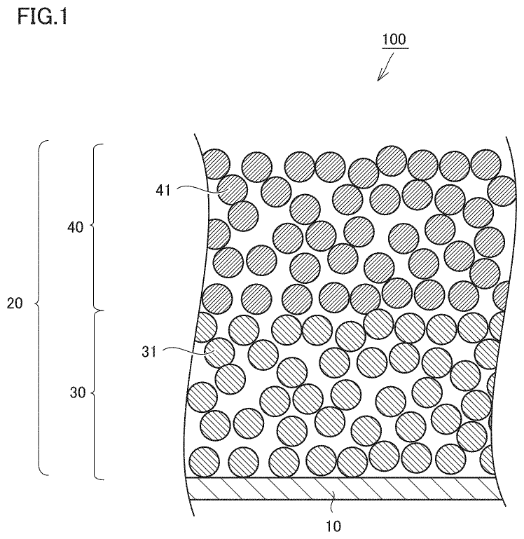

A negative electrode according to the present disclosure will be described with reference to figures. A negative electrode 100 shown in FIG. 1 is a negative electrode for a non-aqueous electrolyte secondary battery. Negative electrode 100 includes a current collector 10 and a negative electrode active material layer 20. In negative electrode active material layer 20, a first active material layer 30 and a second active material layer 40 are stacked in this order from the current collector 10 side. In the negative electrode of the present disclosure, the negative electrode active material layer may be provided only on one side of the current collector, or may be provided on each of both sides of the current collector.

Current collector 10 is an electrically conductive sheet. Current collector 10 may include, for example, an aluminum (Al) foil, a copper (Cu) foil, or the like. Current collector 10 may have a thickness of, for example, 5 μm to 50 μm. For example, a coating layer may be formed on a surface of current collector 10. The coating layer may include, for example, an electrically conductive carbon material or the like. The coating layer may have a thickness smaller than that of negative electrode active material layer 20, for example.

The thickness of negative electrode active material layer 20 is preferably 100 μm or more and 260 μm or less, and is more preferably 120 μm or less and 200 μm or more. A packing density of negative electrode active material layer 20 is preferably 1.2 g/cc or more and 1.7 g/cc or less, and is more preferably 1.45 g/cc or more and 1.65 g/cc or less. Negative electrode active material layer 20 may be provided with pores. When negative electrode active material layer 20 is provided with the pores, a porosity is preferably 20% or more and 35% or less.

First active material layer 30 includes first silicon-containing particles 31. Second active material layer 40 includes second silicon-containing particles 41. First silicon-containing particles 31 and second silicon-containing particles 41 may be the same or different in type. Each of first silicon-containing particles 31 and second silicon-containing particles 41 is constituted of a carbon domain and a silicon domain having a nano size, and is preferably constituted of a carbon domain and a silicon domain having a size of 50 nm or less. The silicon domain having a nano size is dispersed in the carbon domain matrix. Since the silicon domain has a nano size, cracking of the silicon-containing particles tends to be likely to be suppressed. The size of the silicon domain is measured in accordance with a method described in the below-described section of Examples.

Each of first silicon-containing particles 31 and second silicon-containing particles 41 has an oxygen content ratio of 7 wt % or less. Since the oxygen content ratio is in the above range, a capacity tends to be likely to be improved. The oxygen content ratio is measured in accordance with the method described in the below-described section of Examples.

Each of first silicon-containing particles 31 and second silicon-containing particles 41 may be provided with pores therein. When each of first silicon-containing particles 31 and second silicon-containing particles 41 is provided with pores therein, a porosity is preferably 3 volume % or more. A surface of each of first silicon-containing particles 31 and second silicon-containing particles 41 may be coated with amorphous carbon.

Each of a content ratio of first silicon-containing particles 31 in first active material layer 30 and a content ratio of second silicon-containing particles 41 in second active material layer 40 may be, for example, 1 wt % or more and 30 wt % or less, is preferably 1 wt % or more and 20 wt % or less, and is more preferably 1 wt % or more and 10 wt % or less.

First active material layer 30 further includes a first binder (not shown). Second active material layer 40 further includes a second binder (not shown). Each of the first binder and the second binder includes carboxymethyl cellulose (CMC). Since each of the first binder and the second binder includes the CMC, the carbon domain tends to be likely to bind the silicon-containing particles that are to be greatly expanded and contracted and that exist at the surface thereof. A content ratio of the CMC in second active material layer 40 is more than a content ratio of the CMC in first active material layer 30. Thus, the second active material layer located on the surface layer side with respect to the first active material layer is likely to be suppressed from being broken during rolling, with the result that a decrease in binding of the active material tends to be likely to be suppressed. The content ratio of the CMC in second active material layer 40 is preferably 0.7 wt % or more and 3 wt % or less. The content ratio of the CMC in first active material layer 30 is preferably 0.5 wt % or more and 1.5 wt % or less.

A molecular weight of the CMC in second active material layer 40 is preferably more than a molecular weight of the CMC in first active material layer 30 in view of suppression of breakage of second active material layer 40 during rolling. The molecular weight of the CMC in second active material layer 40 may be, for example, 300,000 or more, and the molecular weight of the CMC in first active material layer 30 may be, for example, 300,000 or less.

For example, each of the first binder and the second binder may further include at least one selected from a group consisting of a fluororesin such as a polyvinylidene difluoride (PVdF), poly(vinylidenefluoride-co-hexafluoropropylene) (PVdF-HFP), or polytetrafluoroethylene (PTFE), polyacrylonitrile, polyimide, polyamide, an acrylic resin, polyolefin, polyvinyl alcohol, polyacrylic acid (PAA), polyethylene oxide (PEO), and styrene-butadiene rubber (SBR). A content ratio of all the binders in first active material layer 30 and second active material layer 40 may be, for example, 0.1 wt % or more and 10 wt % or less.

First active material layer 30 can further include first graphite particles. Second active material layer 40 can further include second graphite particles. The first graphite particles and the second graphite particles may be the same or different in type. Each of the first graphite particles and the second graphite particles can be artificial graphite. Each of a BET specific surface area of the first graphite particles and a BET specific surface area of the second graphite particles may be, for example, 3.5 m²/g or less, is preferably 0.5 m²/g or more and 3.5 m²/g or less, and is more preferably 1 m²/g or more and 2.0 m²/g or less. Since each of the BET specific surface areas is within the above range, adhesion to the silicon-containing particles tends to be likely to be increased. The BET specific surface area is measured by a multipoint BET method.

Each of the first graphite particles and the second graphite particles can have any size. Each of a particle size distribution (D90-D10)/(D50) of the first graphite particles and a particle size distribution (D90-D10)/(D50) of the second graphite particles is preferably 1.2 or more. In the present specification, D10, D50, and D90 respectively represent particle sizes corresponding to cumulative particle volumes of 10%, 50%, and 90% from the smallest particle size with respect to the volume of the entire particles in a volume-based particle size distribution. Each of an average particle size of the first graphite particles and an average particle size of the second graphite particles is preferably 8 μm or more and 30 μm or less. In the present specification, the average particle size refers to D50. The particle size distribution and the average particle size can be measured by a laser diffraction/scattering method. A content ratio of the graphite particles in each of first active material layer 30 and second active material layer 40 may be, for example, 70 wt % or more and 99 wt % or less, and is preferably 80 wt % or more and 99 wt % or less.

Each of first active material layer 30 and second active material layer 40 can further include a single-walled carbon nanotube (hereinafter, also referred to as “SWCNT”). The single-walled carbon nanotube can have a function as a conductive material. The single-walled carbon nanotube is preferably a carbon nanostructure in which one layer of carbon hexagon network planes forms one cylindrical shape. The length of the single-walled carbon nanotube is preferably 0.01 μm or more and 5 μm or less. A diameter of the single-walled carbon nanotube is preferably 50 nm or less, and is more preferably 15 nm or less. Since each of first active material layer 30 and second active material layer 40 includes the single-walled carbon nanotube, isolation of the silicon-containing particles tends to be likely to be suppressed. A content ratio of the single-walled carbon nanotube in each of first active material layer 30 and second active material layer 40 may be, for example, 0.001 wt % or more and 0.1 wt % or less.

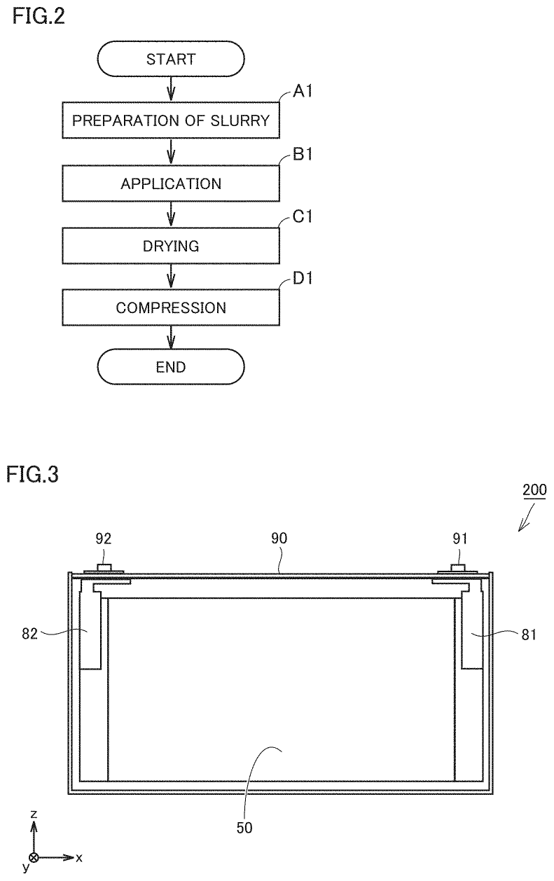

A method of producing negative electrode 100 can include preparation of a slurry (A1), application (B1), drying (C1), and compression (D1). FIG. 2 is a schematic flowchart showing the method of producing negative electrode 100. In the present disclosure, first active material layer 30 can be first formed on current collector 10, and then second active material layer 40 can be formed on first active material layer 30.

The preparation of the slurry (A1) can include mixing an active material, a binder, and a solvent (water). Any amount of the solvent is usable. That is, the slurry can have any solid content concentration (solid content mass fraction). The slurry may have a solid content concentration of, for example, 40% to 80%. Any stirring apparatus, mixing apparatus, and dispersing apparatus can be used for the mixing.

The application (B1) can include applying the slurry onto a surface of a substrate so as to form an applied film. In the present embodiment, the slurry can be applied to the surface of the substrate by any application apparatus. For example, a slot die coater, a roll coater, or the like may be used. The application apparatus may be capable of multi-layer application.

The drying (C1) can include heating the applied film to dry. In the present embodiment, any drying apparatus can be used as long as the applied film can be heated. For example, the applied film may be heated by a hot air dryer or the like. By heating the applied film, the solvent can be evaporated. Thus, the solvent can be substantially removed.

The compression (D1) can include compressing the dried applied film so as to form an active material layer. In the present embodiment, any compression apparatus can be used. For example, a rolling machine or the like may be used. The dried applied film is compressed to form the active material layer, thereby completing negative electrode 100. Negative electrode 100 can be cut into a predetermined planar size in accordance with the specification of the battery. Negative electrode 100 may be cut to have a planar shape in the form of a strip, for example. Negative electrode 100 may be cut to have a quadrangular planar shape, for example.

FIG. 3 is a schematic diagram showing an exemplary battery according to the present embodiment. The battery is a non-aqueous electrolyte secondary battery. The battery is preferably a prismatic battery. A battery 200 shown in FIG. 3 includes an exterior package 90. Exterior package 90 accommodates an electrode assembly 50 and an electrolyte (not shown). Electrode assembly 50 is connected to a positive electrode terminal 91 by a positive electrode current collecting member 81. Electrode assembly 50 is connected to a negative electrode terminal 92 by a negative electrode current collecting member 82. Electrode assembly 50 may be any of a wound type and a stacked type. Electrode assembly 50 preferably has a flat shape. Electrode assembly 50 includes negative electrode 100. In FIG. 3, when a distance (length in the Y direction) between electrode assembly 50 and exterior package 90 as viewed in the X direction is defined as D and the thickness (length in the Y direction) of electrode assembly 50 is defined as T, a ratio T/D is preferably 2% or more at a voltage of 3 V or less. A resin sheet (electrode assembly holder) may be disposed between electrode assembly 50 and exterior package 90.

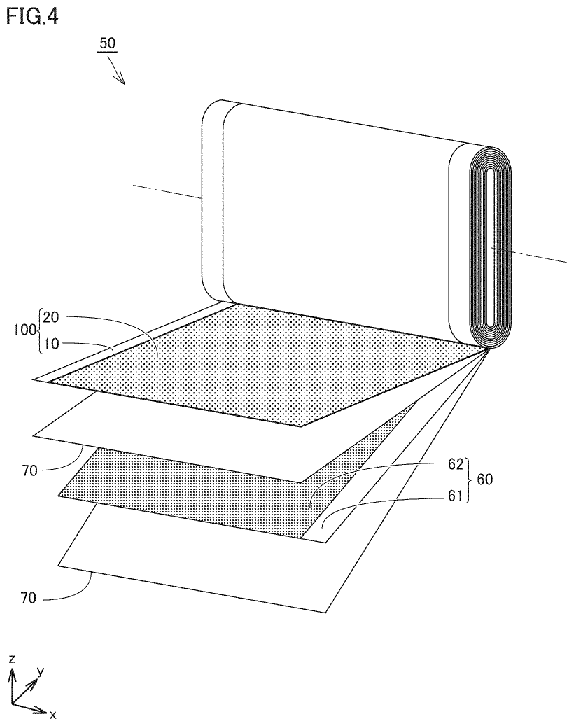

FIG. 4 is a schematic diagram showing an exemplary electrode assembly according to the present embodiment. Electrode assembly 50 is the wound type. Electrode assembly 50 includes a positive electrode 60, a separator 70, and negative electrode 100. That is, battery 200 includes negative electrode 100. Positive electrode 60 includes a positive electrode active material layer 62 and a positive electrode current collector 61. Negative electrode 100 includes negative electrode active material layer 20 and current collector (negative electrode current collector) 10.

### EXAMPLES

Hereinafter, the present disclosure will be described more in detail with reference to examples. The notations “%” and “parts” in the examples represent mass % and parts by mass, unless otherwise indicated particularly.

### Example 1

[Production of Negative Electrode]

A negative electrode active material [graphite particles (D10=12 μm, D50=22 μm, D90=40 μm, BET specific surface area=1.4 m²/g], Si-containing particles (SiC) (D50=3 μm), a conductive material [fibrous carbon (SWCNT, CNT consisting of one layer)], a binder [CMC (molecular weight: 200,000 to 300,000; 1% viscosity: 3500 mPa s), PAA, SBR] and a solvent (water) were kneaded using a stirrer/granulator, thereby obtaining a first slurry. The first slurry had the following blending ratio (mass ratio): graphite/SiC/SWCNT/CMC/PAA/SBR=94/6/0.02/0.7/1/1. The produced first slurry was applied onto a 10-μm Cu foil and was dried, thereby forming a first active material layer. An applied coating on each of the both surfaces thereof was 107 m²/g.

A negative electrode active material [graphite particles (D10=12 μm, D50=22 μm, D90=40 μm, BET specific surface area=1.4 m²/g], Si-containing particles (SiC) (D50=3 μm), a conductive material [fibrous carbon (SWCNT, CNT consisting of one layer)], a binder [CMC (molecular weight: 300,000 to 380,000; 1% viscosity: 6500 mPa s), PAA, SBR] and a solvent (water) were kneaded using a stirrer/granulator, thereby obtaining a second slurry. The second slurry had the following blending ratio (mass ratio): graphite/SiC/SWCNT/CMC/PAA/SBR=94/6/0.02/1.3/1/1. The produced second slurry was applied onto the first active material layer and was dried, thereby forming a second active material layer. An applied coating on each of the both surfaces thereof was 215 m²/g.

After that, pressing was performed to attain a predetermined thickness and processing was performed to attain a predetermined size, thereby obtaining a negative electrode (negative electrode plate). The negative electrode had a thickness of 135 μm and a packing density of 1.60 g/cc. The packing density (g/cc) is calculated by the following formula: packing density Z=X/Y, where the applied coating of the active material layer is X m²/g and the thickness of the active material layer is Y μm.

[Production of Positive Electrode]

A positive electrode active material [lithium-nickel-cobalt-manganese composite oxide (NCM)], a conductive material [acetylene black (AB)], a binder (PVDF) and a solvent (NMP) were kneaded using a stirrer/granulator, thereby obtaining a positive electrode slurry. The positive electrode slurry was produced to attain the following blending ratio (mass ratio): positive electrode active material/conductive material/binder=100/1/1. The produced positive electrode slurry was applied onto a 15-μm A1 foil and was dried, pressing was performed to attain a predetermined thickness, and processing was performed to attain a predetermined size, thereby obtaining a positive electrode plate.

[Production of Non-Aqueous Electrolyte Secondary Battery]

A lead was attached to each of the negative electrode and the positive electrode, and the respective electrodes were stacked with a separator interposed therebetween, thereby producing an electrode assembly. The produced electrode assembly was inserted into an exterior package constituted of an aluminum laminate sheet, a non-aqueous electrolyte was injected thereinto, and an opening of the exterior package was sealed, thereby producing a test cell (laminate cell). For the non-aqueous electrolyte, a solvent was used in which 1M LiPF₆ was used as a Li salt with FEC/EC/EMC/DMC=5/15/40/40 (vol %). A ratio T/D of a thickness T of the electrode assembly to a distance D between the electrode assembly and the exterior package was 2% or more at a voltage of 3 V or less.

[Evaluation on Size of Silicon-Containing Domain]

The negative electrode plate was subjected to an FIB process, was then observed with a STEM (JEM Scanning Transmission Electron Microscope provided by JEOL) to confirm elements (Si, C) by EDX mapping, and then the size of the silicon-containing domain was determined from shape and contrast obtained in an HAADF image (High-Angle Annular Dark Field High Angle Scattering Dark image) of a BF image (bright field image). A result is shown in Table 1.

[Measurement of Oxygen Content Ratio]

An oxygen analyzing apparatus (EMGA-830 provided by Horiba) was used. An amount of oxygen was extracted by a hot melting method in an inert gas. A sample was melted in a flux of Ni/Sn, O in the sample was converted to CO or CO₂ gas, and an amount thereof was measured, thereby obtaining an oxygen content ratio. A result is shown in Table 1.

[Measurement of BET Specific Surface Area]

A predetermined weight of the negative electrode active material was inserted into a cell and measurement was performed. After the measurement, a BET specific surface area per weight of the active material was calculated. A result is shown in Table 1.

[Evaluation on Cycle Retention]

After performing CCCV charging (0.33 C_4.15 V_0.1 C cut) under an environment of 45° C., a cycle test was performed until 150th cycle was reached with CC discharging (0.33 C_3 V cut) being regarded as one cycle. A cycle retention was defined as follows: (discharging capacity of 150th cyc)/(discharging capacity of 1st cyc). A result is shown in Table 1.

### Comparative Examples 1 to 3

Each of non-aqueous electrolyte secondary batteries was produced in the same manner as in Example 1 except that silicon-containing particles shown in Table 1 were used in the first and second active material layers and content ratios of CMC in the first and second active material layers were changed to ratios shown in Table 1. Results are shown in Table 1.

TABLE 1

| | Silicon-Containing Particles | | | Second Active | First Active | |
|---|---|---|---|---|---|---|
| | Silicon | Oxygen | | Material Layer | Material Layer | |
| | Domain | Content | | CMC | CMC | Cycle |
| | Size | Ratio | D50 | Content | Content | Retention |
| | (nm) | (wt %) | (μm) | Ratio (wt %) | Ratio (wt %) | (%) |
| Example 1 | 50 | 5 | 3 | 1.3 | 0.7 | 92 |
| Comparative | 50 | 5 | 3 | 1 | 1 | 88 |
| Example 1 | | | | | | |
| Comparative | 1000 | 8 | 10 | 1 | 1 | 81 |
| Example 2 | | | | | | |
| Comparative | 50 | 35 | 7 | 1 | 1 | 85 |
| Example 3 | | | | | | |

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A negative electrode for a non-aqueous electrolyte secondary battery, the negative electrode comprising a current collector, a first active material layer, and a second active material layer that are provided in this order, wherein
the first active material layer includes first silicon-containing particles and a first binder,
the second active material layer includes second silicon-containing particles and a second binder,
each of the first silicon-containing particles and the second silicon-containing particles contains a carbon domain and a silicon domain dispersed in the carbon domain and having a nano size,
each of the first binder and the second binder contains carboxymethyl cellulose (CMC), and
a content ratio of the carboxymethyl cellulose in the second active material layer is more than a content ratio of the carboxymethyl cellulose in the first active material layer.

2. The negative electrode according to claim 1, wherein the content ratio of the carboxymethyl cellulose in the second active material layer is 0.7 wt % or more and 3 wt % or less, and the content ratio of the carboxymethyl cellulose in the first active material layer is 0.5 wt % or more and 1.5 wt % or less.

3. The negative electrode according to claim 1, wherein each of the first silicon-containing particles and the second silicon-containing particles is constituted of the carbon domain and the silicon domain having a size of 50 nm or less, and has an oxygen content ratio of 7 wt % or less.

4. The negative electrode according to claim 1, wherein
the first active material layer includes first graphite particles,
the second active material layer includes second graphite particles, and
each of a BET specific surface area of the first graphite particles and a BET specific surface area of the second graphite particles is 3.5 m²/g or less, and each of a particle size distribution (D90-D10)/(D50) of the first graphite particles and a particle size distribution (D90-D10)/(D50) of the second graphite particles is 1.2 or more.

5. The negative electrode according to claim 1, wherein each of the first active material layer and the second active material layer includes a single-walled carbon nanotube.

6. The negative electrode according to claim 1, wherein a molecular weight of the carboxymethyl cellulose in the second active material layer is more than a molecular weight of the carboxymethyl cellulose in the first active material layer.

7. A non-aqueous electrolyte secondary battery comprising: the negative electrode according to claim 1; and an exterior package.

8. The non-aqueous electrolyte secondary battery according to claim 7, comprising an electrode assembly including the negative electrode, wherein a ratio T/D of a thickness T of the electrode assembly to a distance D between the electrode assembly and the exterior package is 2% or more at a voltage of 3 V or less.
